(19) United States
(12) Patent Application Publication
(10) Pub. No.: US 2026/0370515 A1
(43) Pub. Date: Nov. 19, 2026

(54) METHOD FOR TESTING A COMMUNICATION BUS

(71) Applicant: Continental Automotive Technologies GmbH, Hannover (DE)

(72) Inventors: Helge Zinner, Regensburg (DE); Daniel Hopf, Maxhütte-Haidhof (DE)

(73) Assignee: Continental Automotive Technologies GmbH, Hannover (DE)

(21) Appl. No.: 19/138,574

(22) PCT Filed: Dec. 1, 2023
(86) PCT No.: PCT/DE2023/200240

§ 371 Date: Jun. 12, 2025

(30) Foreign Application Priority Data
Dec. 13, 2022 (DE) 10 2022 213 583.0

(51) Int. Cl. H04L 12/413; H04L 12/40

(52) U.S. Cl. CPC H04L 12/413; H04L 2012/40273

(57) ABSTRACT

The integrity of communication is monitored between network devices that are connected via a shared communication medium by: listening-in on at least certain parts of the communication on the communication medium within a transmit cycle. Listening-in includes detecting and evaluating data bits or octets which indicate the start and end of the transmit cycle, and the start and end of a transmission by a network device. Listening-in further includes detecting and evaluating a transmit opportunity that is not used by a network device within a transmit cycle. The duration of a transmit cycle is determined and a data volume transmitted within the transmit cycle or a data rate attained for the transmit cycle. By comparing a data volume expected within the transmit cycle or the nominal data rate with the transmitted data volume or the attained data rate, the integrity of the communication on the communication medium can be monitored.

### CROSS-REFERENCE TO RELATED APPLICATIONS

The present application is a National Stage Application under 35 U.S.C. § 371 of International Patent Application No. PCT/DE2023/200240 filed on Dec. 1, 2023, and claims priority from German Patent Application No. 10 2022 213 583.0 filed on Dec. 13, 2022, the disclosures of which are herein incorporated by reference in their entireties.

### TECHNICAL FIELD

The present invention relates to communication via a communication medium shared by a plurality of network devices, in particular to monitoring the integrity of the communication.

In this document, the term communication medium is used to represent wireless or wired or other media-bound transmission media, i.e. is synonymous with acoustic signals, light waves, radio waves, or electrical signals carried via electrical conductors, unless the context necessarily dictates the use of one of these communication media.

A wide range of technology areas require secure communication between a plurality of network devices. Communication can be implemented through point-to-point connections via routers and switches, for example as in most Ethernet and Internet Protocol (IP)-based networks, or via communication channels shared by a plurality of network devices, including wireless connections or wired bus connections.

In the field of industrial automation, various field buses are used, such as EtherCAT, RS-485, UARTs, etc. In the automotive world, MOST, CAN, LIN and other networks are used that require complex gateway devices for communication with other domains. In the computer server market, I2C, GPIO, SPI and even CAN from the automotive world are used to manage various subsystems.

Each of these subsystems uses its own hardware interface, in each case having a different EMC behavior, different software stacks being used for this purpose. By contrast, an end-to-end Ethernet-based network architecture offers many advantages, since it always operates with the same protocol, regardless of the physical layer. A data frame always looks the same, regardless of its transmission at 10 Mbps or 10 Gbps. The bandwidth scaling for specific applications does not require complex gateways. A single switch can often be equipped with appropriate interfaces that enable communication at different speeds. The data frames can then switch from one domain to another without modifying the data by means of appropriate caching.

In many applications, the use of conventional Ethernet connections is not feasible for reasons of complexity, space, weight, cost or for other reasons. For example, an electrical Ethernet connection, which is designed as a point-to-point connection between two network devices or a network device and a switch with a line, requires a dedicated physical interface at each end of the line, commonly referred to as PHY, which is responsible for encoding and decoding data between the digital system side and a propagation or transmission medium. A switch requires a separate PHY for each network device connected to it, thus requiring a large number of ports in a network. A system 10 having four network devices 12, 14, 18, and 20 connected via a switch 16 is shown by way of example in FIG. 1. A total of eight physical interfaces are required for the four point-to-point connections so that all five network devices can communicate with each other.

Ethernet systems in which a bus topology is used (10BASE2, 10BASE5) are known from the early years of Ethernet. An example of a topology of this type is shown in FIG. 2. A coaxial cable 22 connects the five network devices 12, 14, 16, 18 and 20. Each of the network devices 12, 14, 16, 18 and 20 is connected to the coaxial cable 22 via a spur line and a connection box 12a, 14a, 16a, 18a and 20a. In connection boxes 12a, 14a, 16a, 18a and 20a, in the case of 10BASE5 Ethernet, the outer conductor of the coaxial cable 22 is interspersed with piercings and a contact pin is brought into contact with the inner conductor of the coaxial cable 22 without coming into contact with the outer conductor. In the case of 10BASE2, the spur lines are connected via T-connectors with BNC connections. Although the number of physical interfaces to the bus line is reduced to five, a coaxial cable is required in each case for the known Ethernet bus topology, said cable having considerable disadvantages in terms of, inter alia, cost, handling and weight compared to an conductor pair that is optionally twisted. In addition, connecting each network device to the bus line requires a special connection box or at least a T-connector for coaxial cables, which in turn requires substantial outlay.

In order to make the use of Ethernet connections more attractive in other fields of application, a new variant of the Ethernet standard has been developed which offers a bandwidth of 10 Mbps over a physical layer with a single conductor pair: IEEE Std 802.3cg-2019. One of the variants specified under this IEEE standard is known as 10BASE-T1S, where the S stands for short reach, and which can use a multidrop or bus topology in which all nodes are connected via a single two-wire twisted line. This eliminates the need to use switches, i.e. the number of physical interfaces is smaller than in a system with a switch, and no coaxial line is required. The connection of spur lines to a twisted-pair cable can similarly be implemented passively in a simple and cost-effective manner. A long-range variant—known as 10BASE-T1L (L for long reach)—has been defined for distances up to 1 km. The long-reach variant again uses point-to-point connections.

A 10BASE-T1S bus system can be used to interconnect at least eight network devices, wherein the maximum bus length is 25 m. The individual network devices can be connected to the bus line using spur lines each with a maximum length of 10 cm. All nodes share the 10 Mbps bandwidth. FIG. 3 shows, by way of example, a corresponding 10BASE-T1S network with five network devices 12, 14, 16, 18, 20 connected via a shared communication medium 24, e.g. a bus line formed by a twisted wire pair. The dashed line indicates the logical connections between the network devices, and the solid line indicates the physical connections.

To ensure regulated access of individual network devices to the CBUS, the standard specifies an arbitration scheme that allows full utilization of the available bandwidth with reduced latency and high quality of service (QoS). One of the possible arbitration schemes is known as physical layer collision avoidance—PLCA—while another arbitration scheme known as carrier sense multiple access/collision detection—CSMA/CD—can have a lower utilization of bus capacity and can be used, for example, as a fallback option.

The CSMA/CD access method provides every network device with transmission access to the network as soon as no other network device is transmitting. A control facility ensuring that each of the network devices in a network is given the opportunity to transmit data within a specified time period is not included in the CSMA/CD access method and must be provided at a higher protocol level.

The PLCA access method is conceptually similar to a Token Ring method or time division multiple access (TDMA). The PLCA access method configures each network device with a node ID and sets the network device with node ID 0 as the PLCA coordinator. The coordinator initiates a communication cycle by transmitting an agreed sequence of data bits or octets, also referred to as a beacon message or beacon frame. The other nodes use this beacon message to co-ordinate their clocks. The terms beacon message and beacon frame are used synonymously in this description.

In order to determine when the PLCA access method allows it to transmit data, each network device on the bus line “listens” and waits until the network device with a node ID one lower than its own ends the transmission. After each transmit procedure of a network device that can be marked as complete by an agreed sequence of data bits or octets at the end of a transmission, a period referred to as a transmit opportunity or TO time window follows. For example, the TO time window can be 20 bits long, i.e. can correspond to a time period within which 20 bits can be transmitted at the nominal data rate of the data bus. Within this TO time window, the network device which has a node ID that is one higher than that of the network device that terminated its transmission immediately before can begin transmission. Each node is allowed to transmit its entire data, wherein each network device typically transmits one frame only. However, a network device can transmit a plurality of consecutive data frames in what is referred to as burst mode, wherein, by means of commit messages transmitted between the respective data frames, the communication medium is marked as still occupied by the currently transmitting network device. If a network device does not transmit and allows the TO time window reserved for it to elapse, a further TO time window follows for the next network device. Thus, even in a cycle in which not all network devices transmit, the coordinator can identify or assume the end of the cycle, and a new cycle can be started.

After the last network device has received and possibly used the data transfer opportunity, the PLCA coordinator initiates the next cycle with another beacon message.

Access by means of PLCA achieves higher throughput than TDMA or Token Ring because network devices do not have to split their messages across a plurality of time slots. In addition, the transmit opportunity phase with its 20 bits is shorter than a token packet. Since the nodes on the bus can or cannot make use of their transmit opportunity, the duration of a complete transmit cycle cannot be determined exactly in advance.

An example representation of the messages transmitted by network devices in the order of their node IDs via the shared communication medium is shown in FIG. 4. The start of a transmit cycle is initiated with a corresponding bit sequence B, also known as a beacon. This is followed immediately by a TO time window within which the network device with the lowest node ID can begin transmitting its message, i.e. in this case the node ID having the value 0, which also transmitted the beacon bit sequence. The TO time window is represented by shading in the figure. The TO time window for the next network device follows the end of transmission by a network device. The network device that is allowed to transmit can begin transmitting immediately at the start of the TO time window or at some point within the TO time window. The TO time window can be started, for example, by a signal representing the end of a transmission of a network device. This signal can be, for example, an end-of-frame (EOF) signal. The end of a TO time window can be determined by a counter or timer. The end of the TO time window is reached if the network device that is allowed to transmit has not started a transmission during an agreed time period, according to an agreed number of data bits transmitted at the nominal data rate of the shared communication medium. If the start of a transmission is detected before the TO time window elapses, e.g. signaled by a start-of-frame signal (SOF), the counter for the TO time window can be stopped. This procedure is repeated until the last network device transmits its message or allows its TO time window to elapse. A new beacon bit sequence, with which a new transmit cycle is started, is then transmitted. The length or duration of each transmit cycle is determined by the length of the beacon bit sequence, the length of messages transmitted in each case by the network devices, or totally or partially unused TO time windows, and can vary from one transmit cycle to another.

Although the network devices always listen to the communication on the CBUS to determine when they are allowed to transmit, a further check is not performed to determine whether the communication on the CBUS runs fault-free. Errors caused by interruption of the communication medium or by transient faults that can interfere with the transmission of individual data packets cannot be detected. Such errors can occur during operation of the network, for example, in a harsh environment with many sources of interference, as a result of an attack or due to an error in the connection between the physical interface (PHY) and the microcontroller trying to communicate via the interface.

FIG. 5 shows the network in FIG. 3 with an error in the connection between the processor and the network interface of the network device 16. The physical connection between the network interface and bus line 24 is fault-free. However, the transmission of the data by the network device 16 may be incomplete or may have failed completely. An example representation of the error in the sequence of messages transmitted by the network devices in the order of their node IDs via the shared communication medium is shown in FIG. 6. The representation corresponds essentially to that in FIG. 4, except that the message from node 2 is errored. This error may be, for example, that node 2 does not transmit at all, transmits incompletely, or transmits random bit sequences due to an error in the connection between the processor and the network interface. Such an error is not detectable at access control level during normal operation and would have to be detected at higher protocol levels. Such capabilities cannot always be provided, particularly in sensor networks in which individual network devices provide little computing power and memory and must furthermore be particularly cost-effective.

FIG. 7 shows the network from FIG. 3 with an error affecting the bus line 24, for example temporary interference caused by an electromagnetic interference pulse. Here also, the physical connection between the network interface and the bus line 24 is fault-free. Although the fault is shown as local in the figure, it occurs more or less simultaneously on all interfaces due to the short length and low attenuation of the bus line and thus interferes with the correct reception of data bits or octets of a message, for example due to a change in a signal level such that the value of one or more data bits is changed, or due to the application of a voltage level to the receivers of the interfaces that overloads them. An example representation of the error in the sequence of messages transmitted by the network devices in the order of their node IDs via the shared communication medium is shown in FIG. 8. The representation is essentially the same as that in FIG. 4, except that, in the example representation of FIG. 8, the beacon bit sequence is errored, for example due to an electrical or electromagnetic noise pulse at the time when the coordinator transmitted the beacon bit sequence. As a result, the network devices with node IDs greater than 0 will not be able to detect the start of a new transmit cycle and will not transmit their messages. The coordinator will subsequently therefore presumably only recognize TO time windows that are not used by the other network devices and will start a new transmit cycle if the number of elapsed, unused TO time windows is equal to the number of network devices connected via the shared communication medium. For the coordinator, the transmit cycle x+1 shown in FIG. 8 is very short, but for the other network devices the transmit cycle x is longer than for the coordinator. Such a change is not reliably detectable during normal operation on OSI layers 1 and 2 of the communication connection and, as in the error example described with reference to FIG. 5, would have to be detected at higher protocol levels and corrected if necessary.

### BRIEF SUMMARY

If a network of the type described above, in which a multiplicity of network devices are interconnected via a shared communication medium, is used in a system that places high demands on the reliability and security of communication, such as in a system having a plurality of network devices that communicate with each other in connection with partially or highly automated driving, frequent, ideally continuous, integrity control of the communication is essential. In the context of this description, the term network device covers all possible types of network devices, including networked sensors and network devices that process signals from networked sensors.

In order to be able to perform this integrity control even in the event of serious errors anywhere in the network, it may also be desirable to be able to perform this integrity control independently in as many network devices as possible, in order to be able to switch to a safe mode in response to an error, for example. Since the hardware and computing power in many network devices are insufficient to run complex control routines continuously or quasi-continuously, and the use of communication protocols with acknowledgement messages for received data reduces the bandwidth available for data transmission and causes additional delays, there is a great need to be able to carry out simple but reliable integrity control of communications in networks where a plurality of network devices communicate over a shared medium.

One object of the present invention is therefore to provide a method for the integrity control of communication in a network that requires low computing capacity and is also locally executable.

This object is achieved by the method indicated in independent claim 1. Embodiments and developments of the method are indicated in the dependent claims.

A further object of the present invention is to indicate a network device that is configured to carry out the method according to the invention or its embodiments or developments. Further objects of the invention relate to the creation of a system having at least one network device according to the invention as well as a computer program product and a computer-readable medium providing said computer program product in retrievable form.

According to a first aspect of the invention, a method for monitoring the integrity of communication between a plurality of network devices that are connected via a shared communication medium and can in each case transmit a message via the shared communication medium within a transmit cycle initiated and ended by a first network device, also referred to as a coordinator, comprises listening-in on at least certain parts of the communication on the communication medium within the transmit cycle.

The message transmitted by the respective network device can be of any length, i.e. can comprise one or more Ethernet frames, wherein the length of the Ethernet frame(s) can be between 64 and 1518 bytes. In principle, it is also possible to transmit what are referred to as jumbo frames having a greater length, wherein, in this case, all network devices networked via the communication medium must support these jumbo frames. If a network device transmits a plurality of consecutive frames, which is also referred to as burst mode, the network device can transmit a commit signal after a transmitted frame to signal to the other network devices that another frame will follow.

The start of a transmit cycle is marked by a sequence of data bits. The end of a transmit cycle can be represented, for example, by a sequence of data bits that mark the start of a subsequent transmit cycle. Alternatively, the end of a transmit cycle can also be represented by a sequence of data bits that mark the end of the transmission of the last network device. The latter may require that all network devices carrying out the method know at least the number of network devices in the network, for example through corresponding parametrization or through independent learning during operation.

Listening-in accordingly comprises at least detecting and/or evaluating data bits or sequences of data bits that indicate the start and end of a transmit cycle, and data bits or sequences of data bits or octets that indicate the start and end of a transmission by a network device. The start of a transmission by a network device can already be identified by the transmission of an initial data bit within a TO time window. The protocol used can ensure that only one network device that is actually next in line is transmitting. Listening-in also comprises detecting and/or evaluating a transmit opportunity that is not used by a network device within a transmit cycle. If at least one of the network devices in the network transmits messages in burst mode, listening-in also comprises detecting and/or evaluating sequences of data bits representing commit signals. Network devices that also transmit messages in burst mode can notify this, for example, when the network is initialized or, if the number and type of network devices of the system using the network are known from the start and remain unchanged, a corresponding configuration can be carried out in advance in the network devices.

Each network device on the network is assigned a unique node ID, typically a number within an interval starting with 0 and ending with the number n of network devices on the network. The network device with the lowest node ID, i.e. node ID 0, is the first network device, i.e. the coordinator, which initiates the transmit cycle and is furthermore the first that is allowed to transmit its data. Each network device implements a node ID counter that is reset to 0 at the start of each transmit cycle. The node ID counter can be a simple counter implemented in software. With each transmission by a network device on the shared communication medium, for example at the end of a transmission, each network device increments its node ID counter by 1 and compares the counter value of the node ID counter with its own node ID. If the counter value of the node ID counter and a network device's own node ID match one another, this network device itself is allowed to transmit via the shared communication medium once the previous transmission has ended.

As mentioned earlier, a network device does not necessarily have to transmit within a transmit cycle. Detecting and evaluating a transmit opportunity that is not used by a network device can therefore comprise, for example, detecting and evaluating a TO time window. A TO time window has a predetermined duration, for example the duration that would have been required to transmit a predetermined number of data bits at the nominal data rate of the shared communication medium. A TO time window follows the end of a transmission, e.g. a sequence of data bits representing the end of a data frame. As soon as no data bits indicating the start of a transmission by the network device that is currently allowed to transmit are detected for the entire duration of a TO time window, i.e. until said TO time window elapses, each network device increments the node ID counter and waits for the duration of a new TO time window to ascertain whether data bits are received, or itself initiates its transmission via the communication medium if the value of the node ID counter matches its node ID.

A network device can also transmit a commit message during the TO time window if, for example, the network device is not yet ready to transmit the message, but will soon be. In this case, the other network devices wait beyond the end of the TO time window until the network device that transmitted the commit signal has transmitted its message. The next network device having a node ID that matches the counter value can then transmit in the following TO time window.

According to the invention, the method also comprises determining the duration of a transmit cycle. The duration of a transmit cycle can be determined, for example, by measuring the time that has elapsed between two consecutive sequences of data bits indicating the start of a transmit cycle. If the end of a transmit cycle is signaled by a sequence of data bits that marks the end of the transmission of the last network device, the time that has elapsed between the start of the transmit cycle and this sequence can be measured. Since the length of the transmit cycles can vary depending on the number of network devices actually transmitting data and the number of data bits or octets transmitted by each network device, the duration of each individual transmit cycle is determined individually.

The data volume transmitted within the transmit cycle is further determined according to the invention and the data volume expected within the transmit cycle is calculated. The determined data volume is then compared with the calculated data volume. Alternatively, the measured duration of the transmit cycle and the data volume transmitted via the communication medium during the transmit cycle can be used to determine a data rate, which is compared to a nominal data rate of the network. If the determined and calculated data volume or the determined and nominal data rate match one another within a tolerance window, the method is repeated for a subsequent transmit cycle. Otherwise, at least one of the network devices that have carried out the method will switch to an error mode.

In error mode, a network device can take different actions depending on the type and severity of the error. For example, information relating to the error can be stored locally in the network device, in a tamper-proof memory that has a communication connection to the network device, and/or in a cloud. The log level, i.e., for example, the data volume and the level of detail of the information that is stored, can also be increased on a case-by-case basis, so that additional data are available for troubleshooting purposes. Alternatively or additionally, the network device can set up its own communication via the shared communication medium, or the network device with the lowest node ID, performing the role of the coordinator, is notified so that, if necessary, it prevents further communication on the data bus. Similarly, it is possible to notify other network devices communicating via the shared communication medium of the error if they do not themselves monitor the integrity of communication via the shared communication medium, so that, if necessary, these network devices can adapt their function according to the error. A fallback to another access mode can also be performed in response to an error, such as the CSMA/CD access mode for the shared communication medium. With carrier-sense multiple access/collision detection (CSMA/CD), communication is no longer performed in cycles initiated by a coordinator and no beacon frames are transmitted. Instead, all network devices listen for possible communication on the communication medium and attempt to transmit if no other network device is transmitting at that time. If collisions occur, the network devices will wait a certain amount of time with randomly generated wait times before attempting to transmit once more. This reduces the net data rate, but, purely statistically, all participants are still given the opportunity to transmit data. Such a change in access control must be communicated to all bus participants in an appropriate manner. The network device with the lowest node ID, for example, could be notified for this purpose, this network device then transmitting a corresponding message to the other network devices. It is easily recognizable that, following a switch to an error mode, monitoring may no longer be possible using the method according to the invention, e.g. if a switchover to the CSMA/CD access method has taken place.

If the method is performed for each transmit cycle, continuous or quasi-continuous monitoring of the integrity of the communication is possible. If the end of a transmit cycle is signaled by the start of a subsequent transmit cycle, listening-in is already initiated for the new transmit cycle and determination of the data volume transmitted in the new transmit cycle begins, while the expected data volume is calculated for the previous cycle and the determined and expected data volumes are compared for the completed transmit cycle. Depending on the application, random monitoring, which is performed in regular cycles or at irregular intervals, can also be sufficient.

The method can also be carried out over a plurality of transmit cycles, i.e. the transmitted data volume can be determined and the expected data volume can be calculated over a plurality of transmit cycles. Similarly, the method can be performed for a shorter period of time than a transmit cycle, even over parts of two consecutive transmit cycles. For example, it would be possible to monitor the integrity of communication for only a selection of network devices. In this case, the “shortened transmit cycle” could be determined by means of the node ID counter. In principle, it is therefore possible to start and also to end the determination of the transmitted data volume within a transmit cycle, or to start within a first transmit cycle and end within a subsequent transmit cycle, i.e. not necessarily in each case at the start and at the end.

Data transmitted via the communication medium which are addressed to the network device carrying out the method are obviously not only used to determine the transmitted data volume, but are also forwarded to higher software layers for further processing.

According to one or more embodiments, determining a data volume transmitted within a transmit cycle or determining the data rate comprises counting all data bits or octets transmitted via the communication medium within a transmit cycle, including, if necessary, those transmitted by a network device itself carrying out the method, provided that it transmits a message within the transmit cycle. This embodiment could be used, for example, on layer 1 of the OSI layer model if the network device carrying out the method is not configured to evaluate the communication at a higher layer of the OSI layer model.

According to one or more embodiments, determining a data volume transmitted within a transmit cycle or determining the data rate comprises detecting the start and end of a network device transmission. The data volume transmitted by a respective network device can be calculated by multiplying the time period between the start and end of the transmission by the nominal data rate of the shared communication medium. The calculated data volumes of all network devices that have transmitted during a transmit cycle are added together.

According to one or more embodiments, determining a data volume transmitted within a transmit cycle or determining the data rate comprises evaluating information contained in transmissions of a transmit cycle relating to the number of data bits or octets transmitted in the respective transmission, possibly including the number of data bits or octets transmitted by a network device itself carrying out the method, if said network device transmits a message within the transmit cycle. Depending on whether the information indicates the total number of transmitted data bits or octets, or only the number of data bits or octets transmitted as payload, the number of data bits or octets can be corrected by the data bits or octets required for the communication protocol, including the number of data bits or octets transmitted to initiate and, if necessary, to end a transmit cycle.

In order to determine the data volume transmitted within a transmit cycle or to determine the data rate, it may be necessary for the network interface of a network device carrying out the method to be set to a special mode in which contents from transmissions not transmitted to the network device are also evaluated. This mode is also known as promiscuous mode. Determining the number of transmitted data bits or octets can then comprise evaluating data transmitted in higher protocol layers relating to the data volume transmitted in a transmission.

The method used to determine the data volume transmitted within a transmit cycle or to determine the data rate, or the type of data collected for this purpose can be selected, for example, depending on the number of network devices interconnected via the shared communication medium, the maximum duration of the TO time window and/or the duration of the sequence of data bits or octets indicating the start and end of the transmit cycle. For example, in one method, the explicit capture of one or more signal components, i.e., for example, the sequence of data bits or octets indicating the start and end of a transmit cycle, the duration of unused TO time windows or commit signals, can be excluded, whereas, in another method, one or more of these signal components are explicitly captured. Especially with a small number of network devices interconnected via the shared communication medium, the capture exclusively of data transmitted by network devices can be selected to determine the data volume transmitted within a transmit cycle or to determine the data rate, since the maximum number of unused TO time windows or the number of data bits or octets that could have been transmitted during the time periods thereof do not attain the shortest possible length of a network device transmission. However, if a larger number of network devices are connected via the shared communication medium, or if one or more network devices transmit a plurality of data frames connected by a commit signal, the capture of signal components may also be necessary.

According to one or more embodiments, determining a data volume transmitted within a transmit cycle or determining the data rate comprises replacing a time period of a TO time window that has elapsed before the start of a transmission or a transmit opportunity not used by a network device with the number of data bits or octets transmittable during the elapsed time period or the duration of a TO time window. The number of bits that could theoretically have been transmitted before the network device actually started transmitting, or the number of data bits or octets that are transmittable during a TO time window can be calculated, for example, from the nominal transmission speed of the shared communication medium and the elapsed time. This number can also correspond to a predefined number of data bits, which is taken into account as being representative of the unused transmit opportunity for determining the data volume transmitted within a transmit cycle, since no data bits or octets are in fact transmitted during an unused TO time window.

In one or more embodiments of the method, the node IDs are permanently assigned to the network devices before or when the system is commissioned. However, it is also possible for the node IDs to be reassigned during operation, for example cyclically at fixed time intervals, to enable access by network devices newly added to the network, or to obtain a continuous sequence of node IDs, e.g. if a network device has been removed from the network. The latter can be notified by the network device in a corresponding message, but it can be also assumed, for example, if a network device has not used a predetermined number of TO time windows of consecutive transmit cycles. Instead of reassigning node IDs in the event that a network device has not used a predetermined number of TO time windows of consecutive transmit cycles, at least the network device carrying out the method can also switch to an error mode. The predetermined value can be different for each network device, and can be notified by means of broadcast messages when the system is commissioned, or can be stored in a memory that can be accessed by the network device carrying out the method.

According to one or more embodiments, calculating a data volume expected within a transmit cycle comprises multiplying the cycle duration by the nominal data rate of the communication medium. This embodiment can be used particularly if transmit cycles immediately follow one another without a major delay.

According to a second aspect of the invention, a network device comprises one or more processors, volatile and non-volatile memories allocated thereto, and a physical network interface which has a communication connection to the one or more processors and is configured for transmission and/or reception via a communication medium shared by a plurality of network devices. The elements of the network device are interconnected for communication by means of one or more data lines or data buses. The non-volatile memory holds computer program instructions which, when they are executed by the at least one processor, configure the network device to implement one or more embodiments of the method according to the invention.

According to a third aspect of the invention, a system, in particular a vehicle system, comprises two or more network devices interconnected via a communication medium shared by a plurality of network devices. According to the invention, at least one of the network devices is configured to implement at least one embodiment of the method according to the invention described above.

A computer program product according to a fourth aspect of the invention contains instructions which, when they are executed by a computer, cause said computer to implement one or more embodiments and developments of the method described above.

The computer program product can be stored on a computer-readable medium or data carrier. The medium or the data carrier can be in a physical embodiment, for example as a hard disk, CD, DVD, flash memory or the like; however, the medium or the data carrier can also comprise a modulated electrical, electromagnetic or optical signal that can be received by a computer by means of a corresponding receiver and can be stored in the memory of the computer.

The method described above and the network devices carrying out the method can advantageously be implemented without changes to existing hardware and can be integrated accordingly into existing networks, since the protocols already used do not need to be changed and the function of the network is not impaired by higher utilization or latencies.

Since the integrity of the communication channels is monitored during ongoing operation, the operational safety of systems such as sensor networks and control units that control and perform actions based on sensor data can be increased, e.g. in vehicles with a high degree of driver support or autonomous vehicles. Errors can be detected quickly and appropriate measures can be instigated more quickly to restore safe operation or to switch to a safe mode.

The method described above and the network devices carrying out the method can be used in a platform-independent and therefore flexible manner due to the simple and lean implementation.

### BRIEF DESCRIPTION OF THE DRAWINGS

The invention will be explained below by way of example with reference to the drawings.

FIG. 1 shows an example of a network known from the prior art having four network devices connected via a switch.

FIG. 2 shows an example of a network known from the prior art having five network devices connected via a 10BASE2 or 10BASE5.

FIG. 3 shows an example of a network known from the prior art having five network devices connected via a twisted wire pair.

FIG. 4 shows an exemplary representation of the messages transmitted by network devices in the order of their node IDs via the shared communication medium.

FIG. 5 shows the network from FIG. 3 with an error in the network interface of a network device.

FIG. 6 shows an exemplary representation of an error in a network device in the sequence of the messages transmitted by the network devices in the order of their node IDs via the shared communication medium.

FIG. 7 shows the network from FIG. 3 with an error affecting the bus line.

FIG. 8 shows an exemplary representation of transient interference affecting the bus line in the sequence of messages transmitted by the network devices in the order of their node IDs via the shared communication medium.

FIG. 9 shows a schematic flow diagram of the basic sequence of the method.

FIG. 10 shows an exemplary schematic flow diagram of the listening-in on the communication on the shared communication medium.

FIG. 11 shows an exemplary schematic flow diagram for selecting one of two possibilities for determining the data volume transmitted via the shared communication medium during a transmit cycle, depending on parameters of the shared communication medium and the network.

FIG. 12 shows an exemplary schematic flow diagram of an alternative method for selecting one of two measurement methods for determining the data volume transmitted via the shared communication medium during a transmit cycle, depending on parameters of the shared communication medium and the network, if at least one network device transmits messages in burst mode.

FIG. 13 shows an exemplary schematic flow diagram for determining the integrity of the communication during a transmit cycle.

FIG. 14 shows a first part of an exemplary schematic flow diagram of a method for determining the data bits or octets transmitted within a transmit cycle on the physical layer.

FIG. 15 shows a second part of an exemplary schematic flow diagram of a method for determining a data volume transmitted within a transmit cycle on the physical layer.

FIG. 16 shows an exemplary block diagram of a network device configured to carry out one or more aspects of the method according to the invention.

Identical or similar elements may be denoted with the same reference signs in the figures.

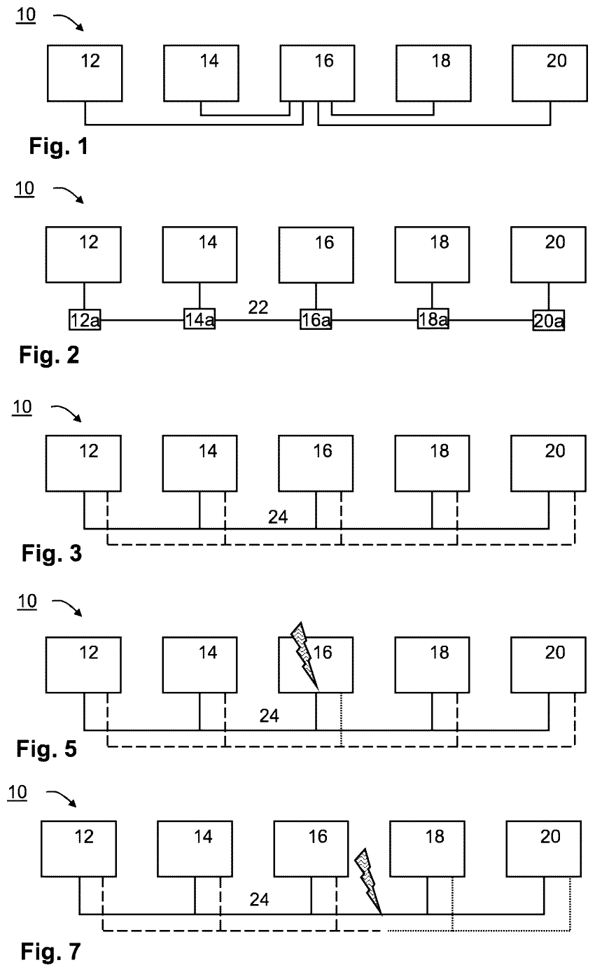

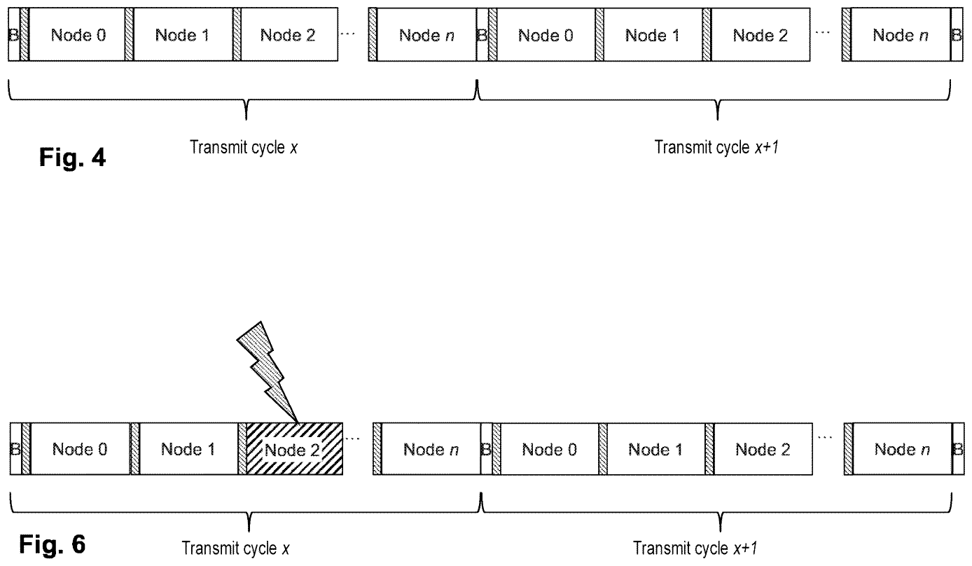

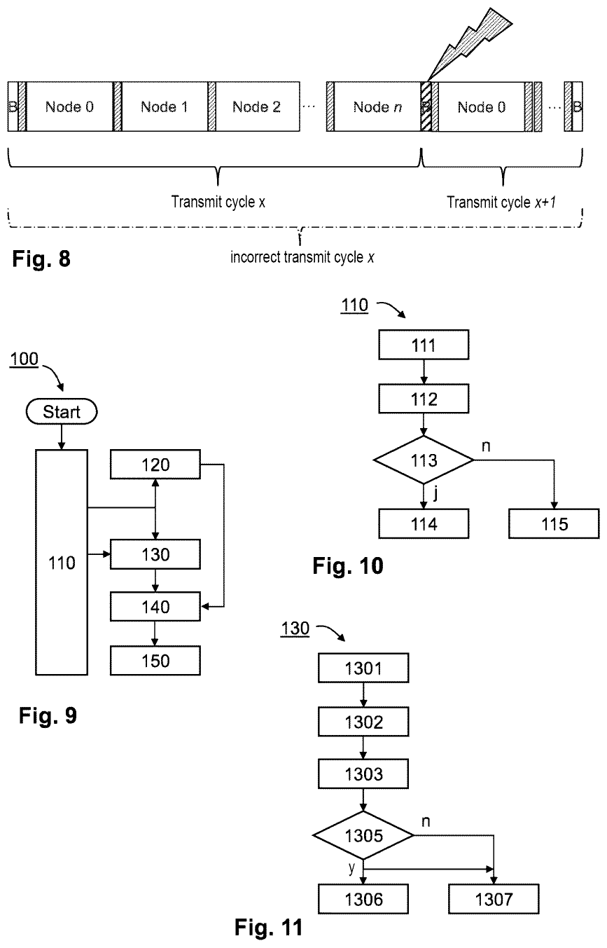

FIGS. 1 to 8 have already been described above and will not therefore be discussed again below.

### DETAILED DESCRIPTION

FIG. 9 shows a schematic flow diagram of the basic sequence of the method 100. In step 110, communication on the shared communication medium is subject to listening-in or monitoring, wherein at least sequences of data bits or octets indicating the start and end of a transmission by a network device are detected and evaluated, and transmit opportunities that are not used by network devices within a transmit cycle are also detected and evaluated. As soon as the start of a transmit cycle has been detected, the determination of its duration begins in step 120. To do this, for example, the time that has elapsed between two consecutive sequences of data bits representing the start of a transmit cycle can be measured.

In parallel, in step 130, the data volume transmitted via the shared communication medium during the transmit cycle is determined, for example by counting the data bits or octets transmitted via the shared communication medium or in other ways. Data from the monitoring in step 110 can also be used here, as indicated by the separate arrow, e.g. special sequences of data bits or octets detected during the monitoring, which serve to control the transmission. A data volume expected within the transmit cycle is calculated in step 140. This can be done, inter alia, on the basis of the duration of the transmit cycle and the nominal data rate of the shared communication medium as well as the number of network devices connected via said shared communication medium. To do this, the duration of the transmit cycle determined in step 120 is added, as indicated by the arrow.

The integrity of the communication via the shared communication medium is checked in step 150. Integrity is determined, for example, by comparing the calculated expected data volume with the data volume determined by monitoring the communication. It is also possible to calculate a data rate from the data volume determined by monitoring the communication and the duration of the transmit cycle, wherein the data rate is compared with the nominal data rate of the shared communication medium. When determining integrity, a tolerance range can be used to suppress both a measurement inaccuracy that is unavoidable due to the lack of synchronization between the network devices and possibly slightly differing transmit data rates of different network devices.

FIG. 10 shows an exemplary schematic flow diagram of the listening-in or monitoring, in step 110, of the communication on the shared communication medium. Only payload data and signals which control the correct performance of the communication of the network devices are to be expected between two sequences of data bits representing the start and end of a transmit cycle. Network devices that can be operated in what is referred to as promiscuous mode can listen in not only on the address data of data packets that are not addressed to them, but also on the further content of the transmissions, or can at least also count the number of data bits or octets from transmissions not directed to them. In step 111, data from a transmission are received accordingly and, in step 112, the length of the transmission, i.e. the number of data bits or octets, is determined or extracted. If a network device carrying out the method can also evaluate the content of transmissions not directed to the network device, such as information contained in a header relating to the length of a transmission, there is no need to count all data bits or octets of the transmission. In this case, it suffices if the network device can identify the end of a transmission, for example by receiving a signal representing the end of a data frame (EOF) or another signal agreed in a protocol that is used. If the transmission is directed to the network device carrying out the method, which is determined by means of a check in step 113, the received data bits or octets are also forwarded in step 114 for further processing in higher protocol layers. Otherwise, the data not required for determining the transmitted data volume can be discarded in step 115, unless they are used for other purposes by the network device carrying out the method. Listening-in or monitoring of the communication on the shared communication medium is repeated at least until a signal representing the end of a transmit cycle, i.e. a corresponding sequence of data bits, is received.

FIG. 11 shows an exemplary schematic flow diagram for selecting one of two possibilities for determining, in step 130, the data volume transmitted via the shared communication medium during a transmit cycle, depending on parameters of the shared communication medium and the network. The number of network devices connected via the shared communication medium is first determined in step 1301, the number of data bits or octets in the sequence of data bits representing the start of a transmit cycle and possibly the end of a transmit cycle is determined in step 1302, and the number of data bits or octets corresponding to the TO time window is determined in step 1303. This information relating to the parameters of the protocol used for communication, also known as signal components, can be read, for example, from a configuration file that is accessible locally or via the network to all network devices carrying out the method. A check is carried out in step 1305 to ascertain whether the total number of data bits or octets of the signal components, which is derived from the sum of the number of data bits or octets in the sequence of data bits representing the start of a transmit cycle and possibly the end of a transmit cycle and the product of the number of network devices connected via the shared communication medium and the number of data bits or octets representing the TO time window, plus a measurement inaccuracy, is equal to or greater than the number of data bits or octets of the shortest possible transmission of a network device, for example the shortest length of a data frame. If the largest possible total number of data bits or octets of the signal components is equal to or greater than the number of data bits or octets of the shortest possible transmission of a network device, the number of data bits or octets of the signal components is determined in step 1306, in addition to the determination in step 1307 of the number of data bits or octets transmitted in the messages of the network devices.

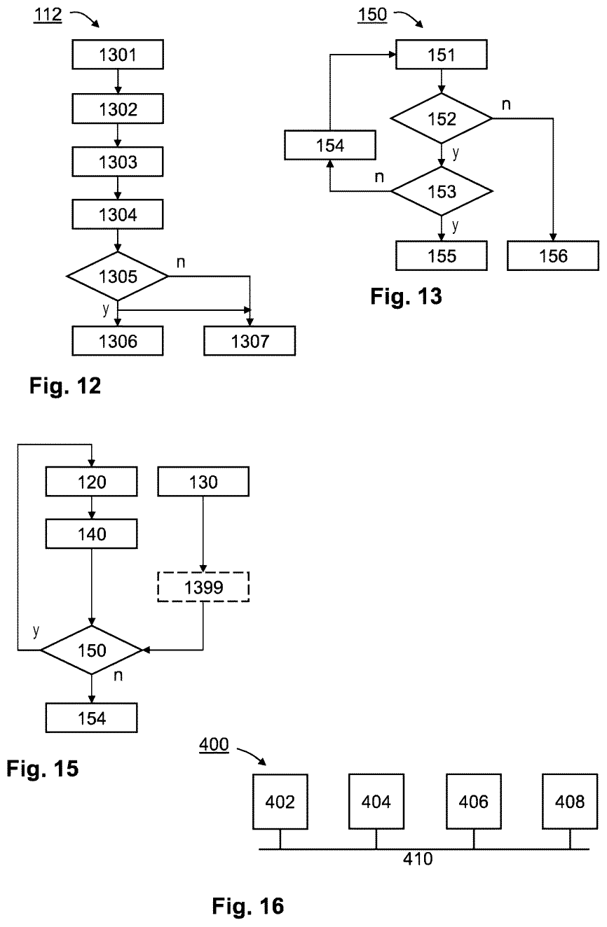

FIG. 12 shows an exemplary schematic flow diagram of an alternative method for selecting one of two measurement methods for determining, in step 130, the data volume transmitted via the shared communication medium during a transmit cycle, depending on parameters of the shared communication medium and the network, when at least one network device transmits messages in burst mode. Steps 1301, 1302, and 1303 correspond to those described with reference to FIG. 11. In addition, the number of network devices that transmit a plurality of consecutive data frames in a message in burst mode is determined in step 1304. If at least one network device transmits in burst mode, a larger number of data bits or octets can occur for signal components within a transmit cycle, inter alia because a network device can transmit up to 255 data frames in succession in burst mode, and a commit signal is transmitted in each case in response to a transmitted data frame, notifying the other network devices in the network that the network device currently actively accessing the communication medium will transmit further data frames. The more network devices transmit additional data bits or octets for signal components, the sooner the number of data bits or octets in the shortest possible message of a network device can therefore be reached or exceeded solely by the sum of the data bits or octets of the signal components, so that it is necessary to also capture the data bits or octets of the signal components and to allow them to be included in the calculation of the number of transmitted data bits or octets or the data rate for a transmit cycle. In the check in step 1305, when determining the number of data bits or octets for signal components, the product of the number of network devices transmitting in burst mode, the number of data bits or octets of the additional TO time windows, and the maximum number of data packets in burst mode, i.e. 255, is added accordingly to the sum described with reference to step 1305 in FIG. 11. If this extended sum, minus a measurement inaccuracy, is equal to or greater than the number of data bits or octets of the shortest possible transmission of a network device, as in the example described with reference to FIG. 11, the number of data bits or octets of the signal components is determined in step 1306, in addition to the determination in step 1307 of the number of data bits or octets transmitted in the messages of the network devices.

FIG. 13 shows an exemplary schematic flow diagram of the steps of a method 150 for determining the integrity of the communication during a transmit cycle. To do this, a “real bus load” is first determined in step 151 by subtracting the number of data bits or octets actually transmitted via the shared communication medium from the maximum number of data bits or octets transmittable at the nominal data rate during the transmit cycle. A check is carried out in step 152 to ascertain whether the real bus load is a positive number. If not, i.e. if more data bits or octets were transmitted within the cycle concerned than would have been theoretically possible, a first type of error must be present and the method follows the “no” branch to step 156, in which this error is signaled and/or otherwise handled. Such an error can occur, for example, because the end of a transmit cycle has not been detected. If the real bus load is a positive number, the method follows the “yes” branch and a check is then carried out in step 153 to ascertain whether the number representing the real bus load is greater than the number of data bits or octets of the shortest possible transmission of a network device, e.g. the shortest length of a data frame. If not, the method follows the “no” branch to step 154, which can comprise, for example, waiting for the determination of the integrity of the communication for the next transmit cycle. If the number representing the real bus load is greater than the number of data bits or octets of the shortest possible transmission of a network device, at least one data frame has been lost and the method follows the “yes” branch to step 155. This second type of error is signaled and/or otherwise handled in step 155.

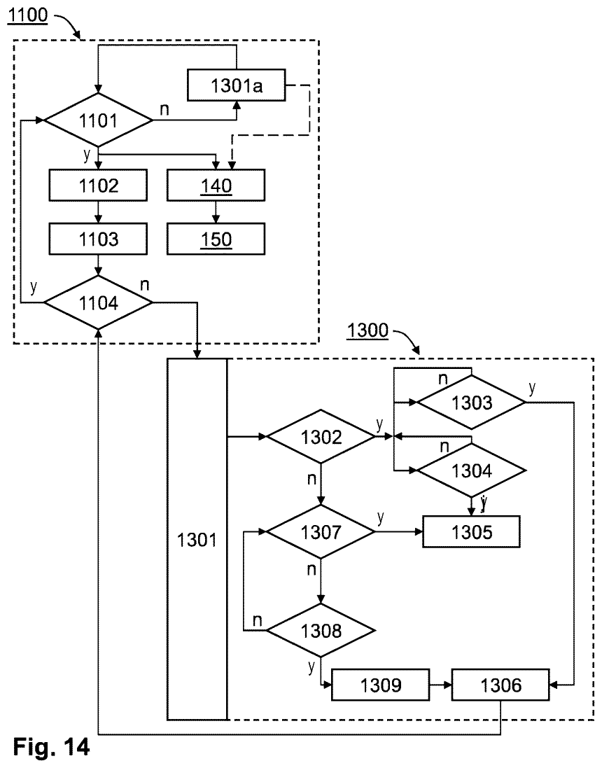

FIG. 14 shows a first part of an exemplary schematic flow diagram of a method 1100 for listening-in and a method 1300 for determining the data bits or octets transmitted within a transmit cycle on the physical layer, i.e. layer 1 of the OSI layer model. This method can be used, for example, if a network device carrying out the method according to the invention does not support listening-in on the communication not intended for the network device itself on layer 2, i.e. the layer 2 frames cannot be analyzed. The data bits or octets that are used for signaling, i.e., for example, the sequences of data bits or octets signaling the start of a transmit cycle (beacon), the start (SOF) or the end of a transmission (EOF) and a further occupancy (commit), are also directly captured with this method.

If necessary, the network device carrying out the method can be initialized before the method begins, wherein, for example, the number of data bits or octets of a message indicating the start or end of a transmit cycle, the number of network devices and their properties and the like are read from a database (not shown in the figure).

A check is first carried out in step 1101 to ascertain whether a sequence of data bits or octets indicating the start of a new transmit cycle has been received. If not, the method branches off to the “no” branch of step 1101 and the check is repeated.

If a sequence of data bits or octets indicating the start of a new transmit cycle has been received, the method branches off on the one hand to the “yes” branch to the methods represented by steps 140 and 150, in which the data volume expected within the previous transmit cycle is calculated and the integrity of the communication is checked for the previous cycle. A flow diagram of an exemplary method 150 which can be used in the analysis on layer 1 of the OSI layer model is described below with reference to FIG. 15. The number of data bits or octets that could have been transmitted while waiting for a sequence of data bits or octets indicating the start of a new transmit cycle is determined or established in step 1301a and is taken into account accordingly when the integrity of the communication is checked, as indicated by the dashed arrow from step 1301a to step 140.

In parallel with the checking of the integrity of the communication, respective counters for the network device that is allowed to transmit next are reset and started in step 1102 for the TO time windows that are not used by network devices and for the number of data bits or octets transmitted during the current transmit period, and a timeout counter for the current TO time window is reset and started in step 1103. A check is carried out in step 1104 to ascertain whether all network devices had the opportunity to transmit in the current transmit cycle, i.e. whether the counter for the network device that is allowed to transmit next has attained a value that corresponds to the last network device in the group of network devices connected via the shared communication medium. If so, i.e. if all network devices had the opportunity to transmit a message during the current transmit cycle, the method follows the “yes” branch from step 1104 back to step 1101 to wait for the next transmit cycle to begin. Otherwise, the method follows the “no” branch from step 1104 to step 1301, in which all data bits or octets transmitted on the shared communication medium are received and counted.

Received sequences of data bits or octets are checked in step 1302 to ascertain whether they indicate the start of a transmission by a network device, for example whether they form a start-of-frame signal or the like. If so, the method follows the “yes” branch of step 1302 and waits, in step 1303, for a sequence of data bits or octets that indicate the end of a transmission by a network device. In parallel, the received data bits or octets are checked in step 1304 to ascertain whether a sequence of data bits or octets indicating the start of a new transmit cycle has been received instead of a sequence of data bits or octets indicating the end of the transmission. If so, corresponding to the “yes” branch of step 1304, an error must be present and the method is continued with step 1305. In step 1305, for example, the network device carrying out the method can be switched to an error mode and/or the network device can report the detected error via the network.

If a sequence of data bits or octets indicating the end of a transmission by a network device is received in step 1303, corresponding to the “yes” branch of step 1303, the counter for the network device that is allowed to transmit next is incremented in step 1306 and the method is continued with step 1104. As already described above, a check is carried out in step 1104 to ascertain whether all network devices had the opportunity to transmit in the current transmit cycle. If not, the part of the method for the next network device beginning with step 1301 is continued.

If the check in step 1302 does not find a sequence of data bits or octets that indicate the start of a transmission by a network device, the method follows the “no” branch of step 1302 and checks in step 1307 whether a received sequence of data bits or octets indicates the start of a transmit cycle. If so, corresponding to the “yes” branch of step 1304, an error must be present since not all network devices connected via the shared communication medium have yet had the opportunity to transmit a message or at least allow their respective TO time window to elapse, and the method is continued with step 1305. In step 1305, as already described above, the network device carrying out the method can be switched, for example, to an error mode and/or the network device can report the detected error via the network. If no sequence of data bits or octets indicating the start of a transmit cycle was detected in step 1307, corresponding to the “no” branch of step 1304, a check is carried out in step 1308 to ascertain whether the timeout counter for the current TO time window has elapsed. If not, corresponding to the “no” branch of step 1308, the receiving or waiting continues while the shared communication medium is unused, i.e. idle, until the timeout count has elapsed, in order to establish whether a data bit marking the start of a transmission or a sequence of data bits or octets indicating the start of a transmission has been detected, i.e. whether the network device has started transmitting.

If the timeout counter for the current TO time window has elapsed, corresponding to the “yes” branch of step 1308, the counter for the TO time windows unused by network devices is incremented in step 1309 and the method is continued with step 1308.

All data bits or octets received in the meantime, including the sequences of data bits or octets indicating the start or end of a transmission, are counted by step 1301 running parallel to the checks of the received data bits or octets. The number of data bits or octets that could have been transmitted by a network device between the start of the TO time window and the start of transmission is added either at this point to the number of data bits or octets transmitted via the shared communication medium, or later when the integrity of the communication is checked.

Data bits or octets intended for the network device carrying out the method are forwarded to higher protocol layers (not shown in the figure).

The data volume in each case transmitted by or determined for a network device using the method described above, said network device currently being allowed to access the shared communication medium, is added to the data volume that has already been transmitted by or determined for other network devices during the current transmit cycle.

FIG. 15 shows an exemplary flow diagram of the steps for determining the duration of a transmit cycle and for checking the integrity of the communication for a transmit cycle. The time that has elapsed between the reception of a sequence of data bits or octets indicating the start of a transmit cycle and the reception of a sequence of data bits or octets indicating the end of a transmit cycle is calculated in step 120. As already mentioned above, the end of a transmit cycle can also be signaled by the start of a following transmit cycle. A timer, for example, which is started at the beginning of a transmit cycle and is stopped at the end of a transmit cycle, can be used for the calculation. It is also possible to write a system time to a memory at the start and end of a transmit cycle and to calculate the duration of the transmit cycle therefrom. Other ways familiar to a person skilled in the art for determining the duration of the transmit cycle are conceivable and are not explained in detail at this point.

A data volume expected within the transmit cycle is then calculated in step 140. This can be done, for example, on the basis of the duration of the transmit cycle and the nominal data rate of the shared communication medium.

In step 150, the data volume determined in step 130, which runs in parallel with the determination of the duration of the transmit cycle, and is transmitted via the shared communication medium during the transmit cycle, is compared with the expected data volume calculated in step 140. If the data bits or octets that are theoretically transmittable during an unused TO time window have not already been taken into account in determining the transmitted data bits or octets, these data bits or octets are determined in step 1399 by multiplying the number of network devices that have not transmitted by the number of data bits or octets theoretically transmittable during a TO time window and adding this to the actually received data bits or octets. If the comparison shows that the data volume expected within the transmit cycle matches the actual data volume transmitted, possibly within a specified tolerance window, corresponding to the “yes” branch of step 150, the integrity of the communication is confirmed during the checked transmit cycle, and the method can be repeated for the following transmit cycle. If the comparison shows that more or fewer data bits or octets were transmitted within the transmit cycle than could have been theoretically transmitted, corresponding to the “no” branch of step 150, the integrity of the communication via the shared communication medium is not confirmed and the network device carrying out the method can switch to an error mode and/or forward the result of the check to other network devices. Depending on whether more or fewer data bits or octets have been transmitted than expected, the network device can switch to different error modes. The possible error modes can include the use of a different method for accessing the shared communication medium, such as CSMA/CD, extended logging of the communication via the shared communication medium, switching the system to safe operation, transmitting one or more messages to a remotely disposed system or the like.

FIG. 16 shows an exemplary block diagram of a network device 400 configured to carry out one or more aspects of the method according to the invention. In addition to a microprocessor 402, the network device 400 also comprises a volatile and a non-volatile memory 404, 406, and a communication interface 408. The elements of the network device are interconnected for communication via one or more data connections or data buses 410. The non-volatile memory 406 contains computer program instructions which, when they are executed by the microprocessor 402, configure the network device to implement at least one embodiment of the method according to the invention.

REFERENCE SIGN LIST

| | | | |
|---|---|---|---|
| 10 | System | 400 | Network device |
| 12 | Network device | 402 | Microprocessor |
| 12a | Connection box | 404 | Volatile memory |
| 14 | Network device | 406 | Non-volatile memory |
| 14a | Connection box | 408 | Communication interface |
| 16 | Network device/switch | 410 | Data connections/data |
| 16a | Connection box | | buses |
| 18 | Network device | 1100 | Listening-in |
| 18a | Connection box | 1101-1104 | “Listening-in” |
| 20 | Network device | | method steps |
| 20a | Connection box | 1300 | Determine transmitted |
| 22 | Coaxial cable | | data volume |
| 24 | Communication | 1301-1307 | “Determine transmitted |
| | medium/wire pair | | data volume” method |
| 100 | Method | | steps |
| 110 | Listening-in | 1399 | Correction of non- |
| 120 | Determine transmit | | transmitted data bits |
| | cycle duration | | or octets |
| 130 | Determine transmitted | | |
| | data volume | | |
| 140 | Calculate expected | | |
| | data volume | | |
| 150 | Check integrity | | |
| 111-115 | “Listening-in” | | |
| | method steps | | |

1. A method for monitoring the integrity of communication between a plurality of network devices that are connected via a shared communication medium and can in each case transmit a message via the shared communication medium within a transmit cycle initiated by a first network device, comprising:
listening-in on at least certain parts of the communication on the communication medium within a transmit cycle, wherein the listening-in comprises at least detecting and/or evaluating data bits or sequences of data bits or octets which indicate the start and end of the transmit cycle, wherein the listening-in also comprises detecting and/or evaluating a transmit opportunity not used by a network device within a transmit cycle,
wherein the method is characterized by the steps of:
determining the duration of a transmit cycle,
determining a data volume transmitted within the transmit cycle or a data rate attained for the transmit cycle,
calculating a data volume expected within the transmit cycle,
comparing the determined and the expected data volume or the determined data rate with a nominal data rate of the communication medium, wherein, if the determined and expected data volume or the determined and the nominal data rate match one another within a predetermined tolerance range, the method is carried out once more for a following transmit cycle, otherwise at least one network device carrying out the method switches to an error mode.

2. The method as claimed in claim 1, wherein determining the data volume transmitted within a transmit cycle or determining the data rate comprises counting all data bits or octets transmitted via the communication medium within a transmit cycle, including, if necessary, those transmitted by a network device itself carrying out the method.

3. The method as claimed in claim 1, wherein determining the data volume transmitted within a transmit cycle or determining the data rate comprises detecting the start and end of a transmission of a network device, wherein the data volume transmitted by a respective network device is calculated by multiplying the time period between the start and end of the transmission by the nominal data rate of the shared communication medium, and wherein the calculated data volumes of all network devices that have transmitted during a transmit cycle are added together.

4. The method as claimed in claim 1, wherein determining the data volume transmitted within a transmit cycle or determining the data rate comprises evaluating information contained in transmissions of a transmit cycle relating to the number of data bits or octets transmitted in the respective transmission, including, if necessary, those transmitted by a network device itself carrying out the method.

5. The method as claimed in claim 1, wherein determining a data volume transmitted within a transmit cycle or determining the data rate comprises replacing a period of time of a TO time window that has elapsed before the start of a transmission or a transmit opportunity not used by a network device with the number of data bits or octets transmittable during the elapsed time period or the duration of a TO time window.

6. The method as claimed in claim 1, wherein calculating a data volume expected within a transmit cycle comprises multiplying the cycle duration by the nominal data rate of the communication medium.

7. A network device, configured to communicate via a communication medium shared by a plurality of network devices, having at least one processor, a volatile and a non-volatile memory and a network interface, wherein the non-volatile memory stores retrievable computer program instructions which, when they are executed by the at least one processor, configure the network device to monitor integrity of communication, wherein the network devices can in each case transmit a message via the shared communication medium within a transmit cycle initiated by a first network device, by performing operations comprising:
listening-in on at least certain parts of the communication on the communication medium within a transmit cycle, wherein the listening-in comprises at least detecting and/or evaluating data bits or sequences of data bits or octets which indicate the start and end of the transmit cycle, wherein the listening-in also comprises detecting and/or evaluating a transmit opportunity not used by a network device within a transmit cycle
wherein the method is characterized by the steps of:
determining the duration of a transmit cycle,
determining a data volume transmitted within the transmit cycle or a data rate attained for the transmit cycle,
calculating a data volume expected within the transmit cycle,
comparing the determined and the expected data volume or the determined data rate with a nominal data rate of the communication medium, wherein, if the determined and expected data volume or the determined and the nominal data rate match one another within a predetermined tolerance range, the method is carried out once more for a following transmit cycle, otherwise at least one network device carrying out the method switches to an error mode.

8. A system, in particular a vehicle system, having two or more network devices interconnected via a communication medium shared by a plurality of network devices, wherein at least one of the network devices is a network device configured to communicate via a communication medium shared by a plurality of network devices, having at least one processor a volatile and a non-volatile memory and a network interface, wherein the non-volatile memory stores retrievable computer program instructions which, when they are executed by the at least one processor configure the network device to monitor integrity of communication, wherein the network devices can in each case transmit a message via the shared communication medium within a transmit cycle initiated by a first network device, by performing operations comprising:
listening-in on at least certain parts of the communication on the communication medium within a transmit cycle, wherein the listening-in comprises at least detecting and/or evaluating data bits or sequences of data bits or octets which indicate the start and end of the transmit cycle, wherein the listening-in also comprises detecting and/or evaluating a transmit opportunity not used by a network device within a transmit cycle,
wherein the method is characterized by the steps of:
determining the duration of a transmit cycle,
determining a data volume transmitted within the transmit cycle or a data rate attained for the transmit cycle,
calculating a data volume expected within the transmit cycle,
comparing the determined and the expected data volume or the determined data rate with a nominal data rate of the communication medium, wherein, if the determined and expected data volume or the determined and the nominal data rate match one another within a predetermined tolerance range, the method is carried out once more for a following transmit cycle, otherwise at least one network device carrying out the method switches to an error mode.

9. (canceled)

10. A non-transitory computer-readable medium having stored thereon computer-executable instructions that, when executed by a processor, cause performance of operations for monitoring integrity of communication between a plurality of network devices that are connected via a shared communication medium and can in each case transmit a message via the shared communication medium within a transmit cycle initiated by a first network device, the operations comprising:
listening-in on at least certain parts of the communication on the communication medium within a transmit cycle wherein the listening-in comprises at least detecting and/or evaluating data bits or sequences of data bits or octets which indicate the start and end of the transmit cycle, wherein the listening-in also comprises detecting and/or evaluating a transmit opportunity not used by a network device within a transmit cycle,
wherein the method is characterized by the steps of:
determining the duration of a transmit cycle,
determining a data volume transmitted within the transmit cycle or a data rate attained for the transmit cycle,
calculating a data volume expected within the transmit cycle,
comparing the determined and the expected data volume or the determined data rate with a nominal data rate of the communication medium, wherein, if the determined and expected data volume or the determined and the nominal data rate match one another within a predetermined tolerance range, the method is carried out once more for a following transmit cycle, otherwise at least one network device carrying out the method switches to an error mode.
